(19) United States
(12) Patent Application Publication
(10) Pub. No.: US 2017/0270601 A1
(43) Pub. Date: Sep. 21, 2017

(54) RENTAL SYSTEM, METHOD AND PROGRAM PRODUCT

(71) Applicant: Yoichiro Nakano, Tokyo (JP)

(72) Inventor: Yoichiro Nakano, Tokyo (JP)

(21) Appl. No.: 15/462,631

(22) Filed: Mar. 17, 2017

(30) Foreign Application Priority Data
Mar. 18, 2016 (JP) 2016-054875

(51) Int. Cl. G06Q 30/06; G06Q 20/10

(52) U.S. Cl. CPC G06Q 30/0645; G06Q 20/10

(57) ABSTRACT

A rental system includes a first means that stores lessee's numbers of first and second keys and a second means that stores lessor's numbers of first keys and second keys. A key receiving means receives rental numbers of first and second keys used for rent payment. A key transfer means subtracts the rental numbers of first and second keys from respective numbers of first and second keys stored in the first means, and adds a sum of the rental numbers of first and second keys to the number of second keys stored in the second means. A sum transmitting means transmits a number of the second keys stored in the second means to a lessor terminal. The first keys are used to settle the rent payment. The second keys are used to settle the rent payment in combination with the first keys.

### CROSS REFERENCE TO RELATED APPLICATION

This application claims Convention priority based on Japanese Patent Application No. 2016-054875 filed on Mar. 18, 2016, the contents of which, including specification, claims and drawings, are incorporated herein by reference in their entirety.

### TECHNICAL FIELD

The present invention relates to a rental system, method and program product, which can reliably ensure profits for a person who mediates between lessors and lessees, or a rental service provider of personal property or real property, hereinafter the person will be referred to as a “mediator”.

### BACKGROUND OF THE INVENTION

Conventionally, for example, a game system described in JP 2013-111399 A (hereinafter referred to as “the '399 Publication”) is known as something related to a rental system.

With the game system described in the '399 Publication, when a user lends a user of a companion a game item such as a tool or weapon used by a character in a game which was acquired in a game machine, a benefit is generated and given to a user as lender.

However, the benefit given to the user as lender in the game system described in the '399 Publication is to be generated when the user as lender has lent a game item to a user as borrower and the user as borrower has played a game with the game item. And no benefit is generated in the case of the user as borrower not playing the game even if the user as borrower has borrowed a game item from the user as lender, or in the case of the user as lender not acquiring a distributable benefit even if the user as borrower has played the game. And so with the game system described in the '399 Publication, the user as lender may not always acquire the benefit even if the user as lender has lent a game item to the user as borrower. Therefore, the game system described in the '399 Publication and configured as described above cannot strongly motivate the user as lender “to lend out a game item to a user of a companion” using a benefit and thus cannot facilitate lending and borrowing between the lender and borrower.

### SUMMARY OF THE INVENTION

A rental system according to an aspect of the present invention, includes a lessee key storing means for storing the number of first keys and the number of second keys associated with a lessee; a lessor key storing means for storing the number of first keys and the number of second keys associated with a lessor; key receiving means; key transfer means; and sum transmission means. The key receiving means receives the number of first keys and the number of second keys used to settle a rent payment from the lessee terminal connected through the communication network. The key transfer means subtracts the number of first keys and the number of second keys used to settle the rent payment received by the key receiving means from the number of first keys and the number of second keys stored in the lessee key storing means respectively, and adds a sum of the number of first keys and the number of second keys used to settle the rent payment to the number of second keys stored in the lessor key storing means, and thereby transfers the first keys used to settle the rent payment as the second keys from the lessee key storing means to the lessor key storing means, The sum transmission means transmits the information of the number of second keys stored in the lessor key storing means after executing the key transfer means to the lessor terminal connected through the communication network. The first keys are essential keys used to settle the rent payment of personal property or real property, the second keys are keys used to settle the rent payment in combination with the first keys.

The rental system may further include a ranking means for ranking users, wherein the ranking means may execute to rank depending on the number of N when a ratio of the number B of second key to the number A of first keys satisfies B/A≦N, where N is an integer equal to or larger than 1.

The system or a method of this invention subtracts the number of first keys and the number of second keys used to settle a rent payment received by the key receiving means (or key receiving step) from the number of first keys and the number of second keys stored in the lessee key storing means (or lessee key storing step) respectively, and adds a sum of the number of first keys and the number of second keys used to settle the rent payment to the number of second keys stored in the lessor key storing means (or by the lessor key storing step). In this way, according to an aspect of the present invention, a rental system can operate smoothly by using two different types of keys.

### BRIEF DESCRIPTION OF DRAWINGS

FIG. 1 is a diagram showing overall configurations of a rental system and user terminal according to a first embodiment of the present invention.

FIG. 2 is a diagram showing a hardware configuration of the management device of the rental system according to the first embodiment of the present invention.

FIG. 3 is a block diagram showing a configuration of the rental system according to the first embodiment of the present invention.

FIG. 4 is a flowchart showing procedures for a user to purchase first keys in the rental system according to the first embodiment of the present invention.

FIG. 5 is a flowchart showing procedures for settling a rent payment in the rental system according to the first embodiment of the present invention.

FIG. 6 is a diagram showing an example of a user profile list in the rental system according to the first embodiment of the present invention.

FIG. 7 is a diagram showing an example of a user profile list in the rental system according to the first embodiment of the present invention.

FIG. 8 is a diagram showing an example of a user profile list in the rental system according to the first embodiment of the present invention.

FIG. 9 is a diagram showing an example of a user profile list in the rental system according to the first embodiment of the present invention.

FIG. 10A is a diagram showing an example of a user profile list in the rental system according to the first embodiment of the present invention.

FIG. 10A is a diagram showing an example of a user profile list in the rental system according to the first embodiment of the present invention.

FIG. 11 is a diagram showing a page of a property list displayed on the user terminal of the rental system according to the first embodiment of the present invention.

FIG. 12 is a diagram showing a page of a Rental Application Form displayed on the user terminal of the rental system according to the first embodiment of the present invention.

### DESCRIPTION OF THE INVENTION

An embodiment of the present invention will be described in detail below with reference to the accompanying drawings.

### Embodiments

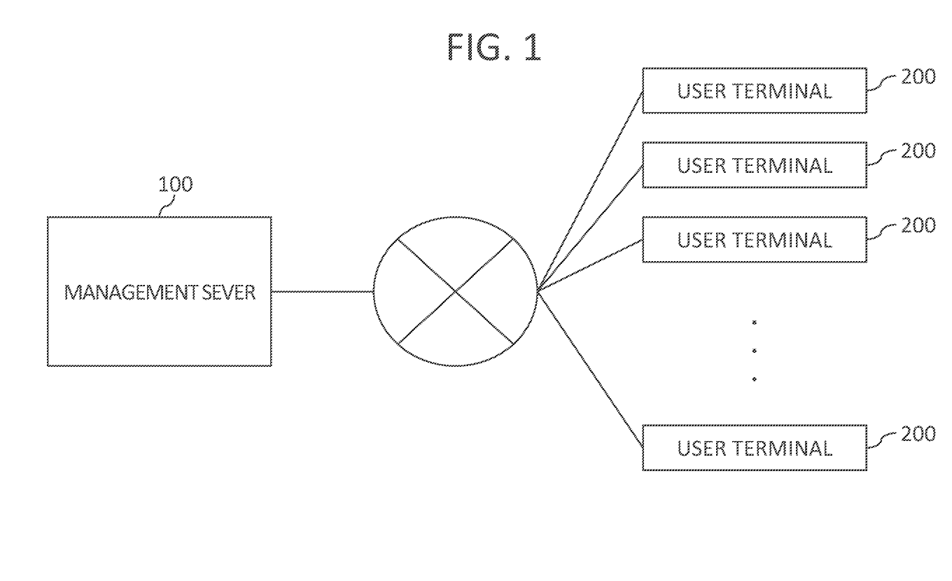

FIG. 1 is a diagram showing overall configurations of a rental system and user terminal according to a first embodiment of the present invention.

A management server 100, which is a main unit of the present rental system, is connected with user terminals 200 through the Internet (there are 1 to N user terminals 200, where N is an integer equal to or larger than 2).) (See the definition of term “user terminal” described below).

Since the present rental system provides a meditating service for renting personal property or real property to a user terminal 200, you can call a person using the user terminal 200 as a user (lessor or lessee) from a viewpoint of the management server 100. Also, an administrator of the management server 100 can be called a mediator who provides the meditating service.

Next, hardware configurations of the management server 100 and user terminal 200 will be described.

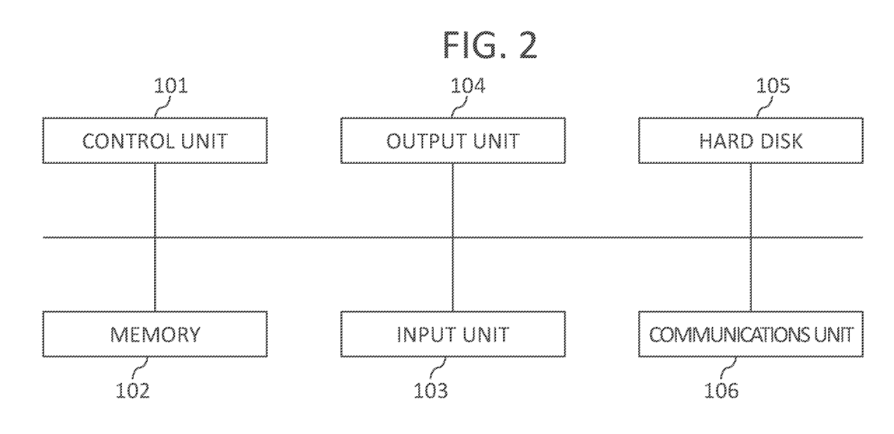

FIG. 2 is a diagram showing a hardware configuration of the management device of the rental system according to the first embodiment of the present invention.

The management server 100 comprises a control unit 101 adapted to control operation of the entire rental system, a memory 102 adapted to store various information such as rental intention information and rental application information described later, an input unit 103 such as a keyboard, an output unit 104 such as a display, a hard disk 105 adapted to store a user profile list 30 and the like described later, and a communications unit 106 adapted to exchange information with the user terminal 200.

The user terminal 200 includes hardware (not shown) having a network connection function, such as a smartphone, a tablet terminal, or a personal computer (PC).

Next, operation of the rental system configured as described above will be described. Note that definitions of terms used herein, i.e., in the claims, specification, and the like, are as follows.

### First Key

A first key is an electronic virtual currency or point which can be used in the present rental system. The first key is always needed whenever a user as lessee rents personal property or real property from a user as lessor in order to settle a rent payment for personal property or real property. The user can use first keys in the present rental system by purchasing from a mediator. Note that the first key may be either exchangeable or unexchangeable with legal currency, that is to say, convertible or non-convertible into cash. Also, the first key may sometimes be referred to herein, i.e., in the specification, as a “gold key.”

### Second Key

A second key is an electronic virtual currency (point) which can be used in the present rental system. The second key can be used to settle a rent payment for personal property or real property only when combined with the first key. Thus, the second key cannot be used alone to settle a rent payment for personal property or real property. When a user as lessor rents out personal property or real property to a user as lessee, second keys are given to the user as lessor. Note that the second key may be either exchangeable or unexchangeable with legal currency, that is to say, convertible or non-convertible into cash. Also, the second key may sometimes be referred to herein, i.e., in the specification, as a “silver key.”

### Lessee Terminal

A lessee terminal is a terminal which a user as lessee operates. Also, the lessee terminal may sometimes be referred to herein, i.e., in the specification, as a “user terminal.”

### Lessor Terminal

A lessor terminal is a terminal which a user as lessor operates. Also, the lessor terminal may sometimes be referred to herein, i.e., in the specification, as a “user terminal.”

### Real Property

Real property may consist of land and one such as building built on the land.

### Personal Property

Personal property refers to movable articles, such as automobiles, clothes, and accessories, distinguished from real property. Note that the concept of “personal property” herein, i.e., in the claims, specification, and the like, includes various articles which can be rented between users, i.e., for example, electronic information such as electronic books, music files, and game elements.

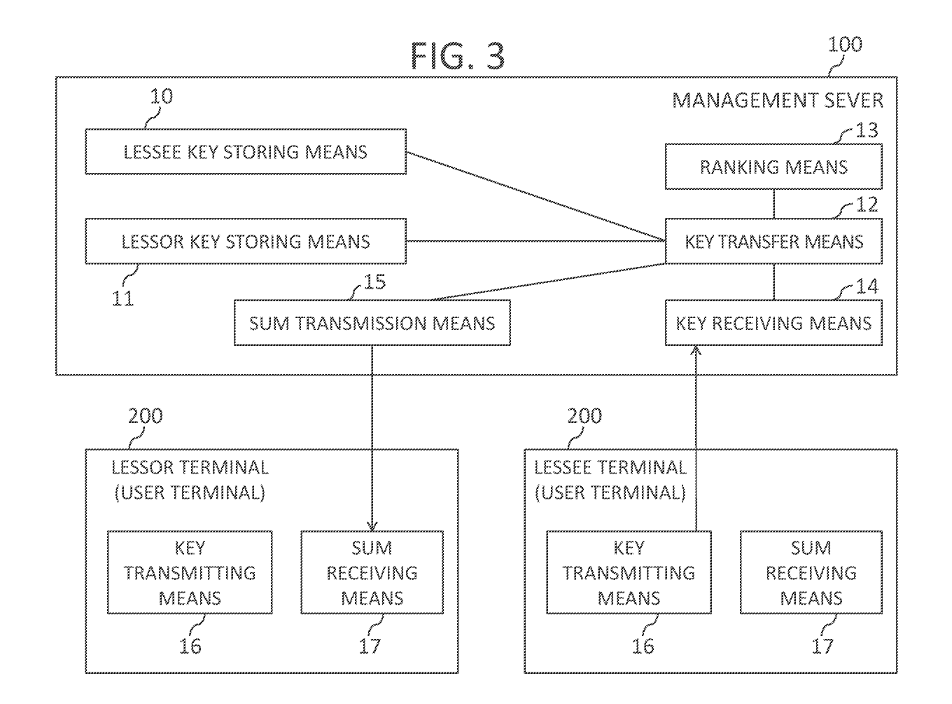

FIG. 3 is a block diagram showing a configuration of the rental system according to the first embodiment of the present invention.

A lessee key storing means 10 and lessor key storing means 11 are storage areas allocated to users on the hard disk 105, and for example, each storage area is allocated to each user. The number of gold keys and the number of silver keys are stored in the storage areas by being associated with the status of the user as lessor or lessee.

Key transfer means 12 first subtracts the number of gold keys and the number of silver keys used to settle a rent payment for personal property or real property from the number of gold keys and the number of silver keys stored in the lessee key storing means 10. And then key transfer means 12 adds the sum of the number of gold keys and the number of silver keys used to settle the payment by the lessee as silver keys to the number of silver keys stored in the lessor key storing means 11, and thereby transfers the gold keys and the silver keys used for the payment as the silver keys.

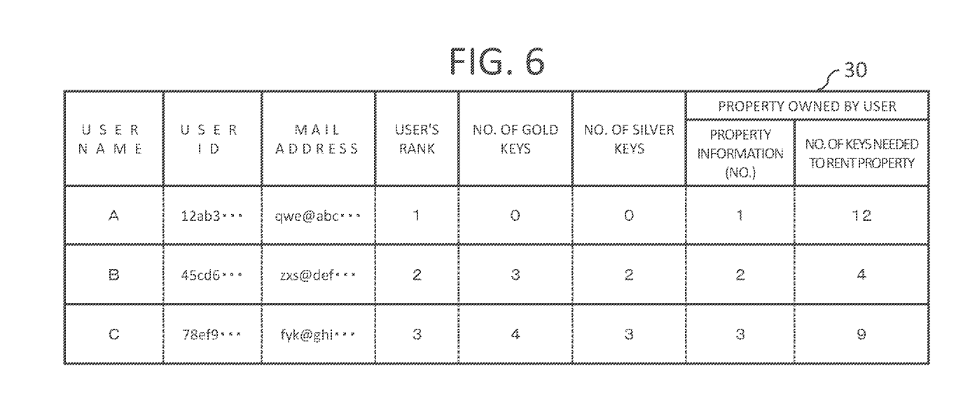

Ranking means 13 updates a rank of the user when the user satisfies a predetermined condition, and stores information thereon into the user profile list 30 (see FIGS. 6 to 10).

Key receiving means 14 receives the number of gold keys and the number of silver keys used to settle a rent payment for personal property or real property via the communication unit 106 from a lessee terminal (user terminal 200) connected through the communication network.

Sum transmission means 15 transmits via the communication unit 106, the information of the number of second keys (the sum of the number of second keys after the addition) stored in the lessor key storing means 11 after key transfer means executing 12 to a lessor terminal (user terminal 200) connected through the communication network.

First, operation of the present rental system will be outlined. In the present embodiment, a second residence owned by a user will be described as an example object to rent, hereinafter the second residence may be referred to as “a property.” Also, in the present embodiment, for example, three users—user A, user B, and user C will appear in the following description as lessors and lessees.

[Operation Overview of the Present Rental System]

When a user, for example, user A rents a second residence owned by the user B, user A as lessee selects the second residence to rent on the user's own user terminal 200 (lessee terminal) and transmits rental intention information about the second residence to the management server 100. Upon receiving the rental intention information from the user terminal 200, the management server 100 transmits a rental application form to the user terminal 200. And user A transmits the number of gold keys and the number of silver keys needed for rent to the management server 100 from the user's own user terminal 200 in order to settle a rent payment for the second residence. The management server 100 receives the number of gold keys and the number of silver keys transmitted from the user terminal 200 and determines if the numbers satisfy a condition for renting the second residence. When the condition is satisfied, the management server 100 subtracts the number of gold keys and the number of silver keys used to settle a rent payment for the second residence from the number of gold keys and the number of silver keys of user A as lessee in the user profile list 30. And the management server 100 adds the sum of the number of gold keys and the number of silver keys used to settle a rent payment for the second residence as silver keys to the number of silver keys of user B as lessor in the user profile list 30. Therefore, the gold keys of user A used to rent the second residence are transferred as silver keys to user B as lessor. This completes settling the rent payment for the second residence.

The management server 100 transmits the sum of the number of silver keys after the addition to the user terminal 200 (lessor terminal) of user B (lessor).

Next, operations of the present rental system will be described in detail with reference to FIGS. 3 to 12. The operations of the present rental system will be described in the following order.
(1) Operation in which a user purchases gold keys
(2) Operation in which a rent payment for a second residence is settled
   (a) Operation in which a payment is settled using only gold keys
   (b) Operation in which a payment is settled using silver keys in combination with gold keys
      (1) Operation in which a User Purchases Gold Keys

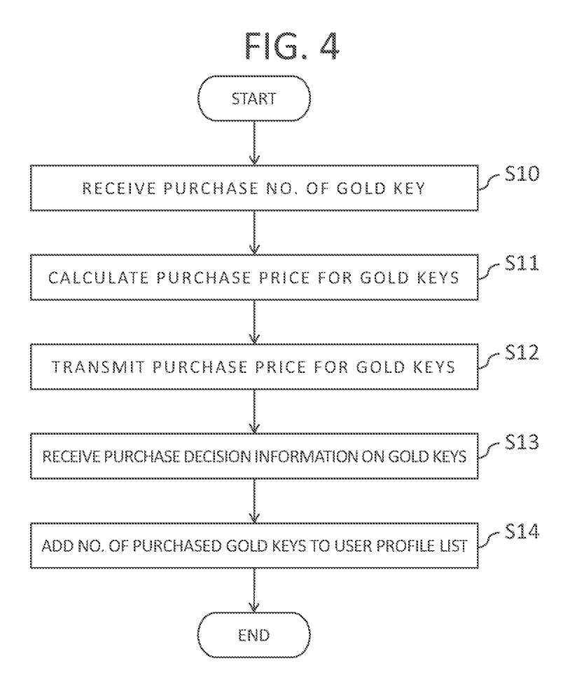

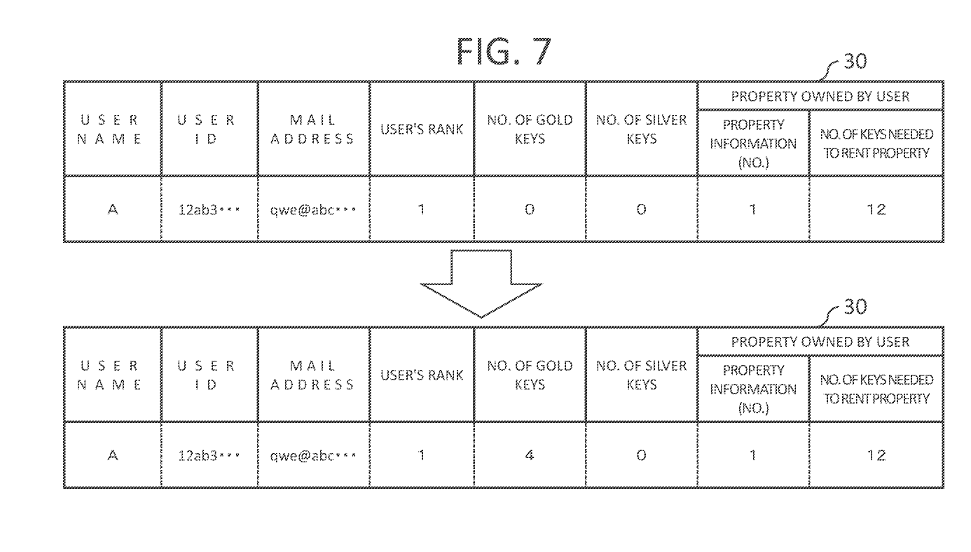

FIG. 4 is a flowchart showing procedures for a user to purchase first keys in the rental system according to the first embodiment of the present invention. FIGS. 6 and 7 are diagrams showing an example of a user profile list in the rental system according to the first embodiment of the present invention.

When a user, for example, user A (see FIG. 6) purchases a gold key from a mediator, user A transmits intended number of gold keys to purchase to the management server 100 from the user's own user terminal 200. Here, it is assumed that user A enters, for example, “4” as the number of gold keys to be purchased and transmits information thereon to the management server 100.

Next, in step S10, the management server 100 receives “4” as the intended number of gold keys to purchase via the communications unit 106, the number being transmitted by user A from the user's own user terminal 200, and then stores the number in the memory 102.

Then, in step S11, the management server 100 calculates a purchase price for the gold keys based on the intended number of gold keys to purchase “4” of the gold key stored in the memory 102. Note that whereas the purchase price for “1” gold key is determined appropriately by the mediator depending on market conditions such as a price situation, description will be given in the present embodiment by assuming, for example, that the purchase price for “1” gold key is “50 dollars.” Thus, in this case, the management server 100 calculates the purchase price for gold keys as “200 dollars.”

### <Calculation Formula of Purchase Price>

4×50 dollars=200 Dollars

* Intended number of gold keys to purchase×purchase price for “1” gold key=purchase price.

Next, in step S12, the management server 100 informs the user terminal 200 of user A about the calculated purchase price for the gold keys, i.e., “200 dollars,” via the communications unit 106. Then, when user A decides on the purchase of gold keys at the purchase price for gold keys informed from the management server 100, user A transmits purchase decision information on the gold keys, which contains the number of gold keys to purchase of “4”, to the management server 100 from the user's own user terminal 200. In step S13, the management server 100 receives the gold key purchase decision information transmitted from the user terminal 200 of user A, via the communications unit 106. The management server 100 stores the received purchase decision information on the gold keys in the memory 102.

Finally, in step S14, based on the gold key purchase decision information stored in the memory 102, the management server 100 adds “4,” which is the number of gold keys purchased by user A, to “0,” which is the number of gold keys of user A on the user profile list 30 stored on the hard disk 105. The management server 100 stores “4,” which is the number of gold keys obtained as a result of the addition (the sum of “0”+“4”), on the hard disk 105 (see FIG. 7).

Note that “the number of gold keys” of each user (e.g., user A, B, or C in FIG. 6) in the user profile list 30 is stored on the hard disk 105 by being associated with the status of the user as lessor or lessee. That is, “the number of gold keys” of each user is stored in the storage area allocated to the given user on the hard disk 105 (e.g., each storage area is allocated to each user), and so “the number of gold keys” is stored in the storage area as “the number of gold keys of a lessor” when the given user is the lessor of the second residence, and as “the number of gold keys of a lessee” when the given user is the lessee of the second residence. Thus, “the number of gold keys” of each user in the user profile list 30 is stored on the hard disk 105 by being associated with the status of the user as lessor or lessee. That is, the hard disk 105 functions as the lessee key storing means 10 or the lessor key storing means 11 depending on the status of the user as lessor or lessee.

This concludes the procedures for a user to purchase gold keys in the present rental system.

(2) Operation in which a Rent Payment for a Second Residence is Settled
(a) Operation in which a Payment is Settled Using Only Gold Keys

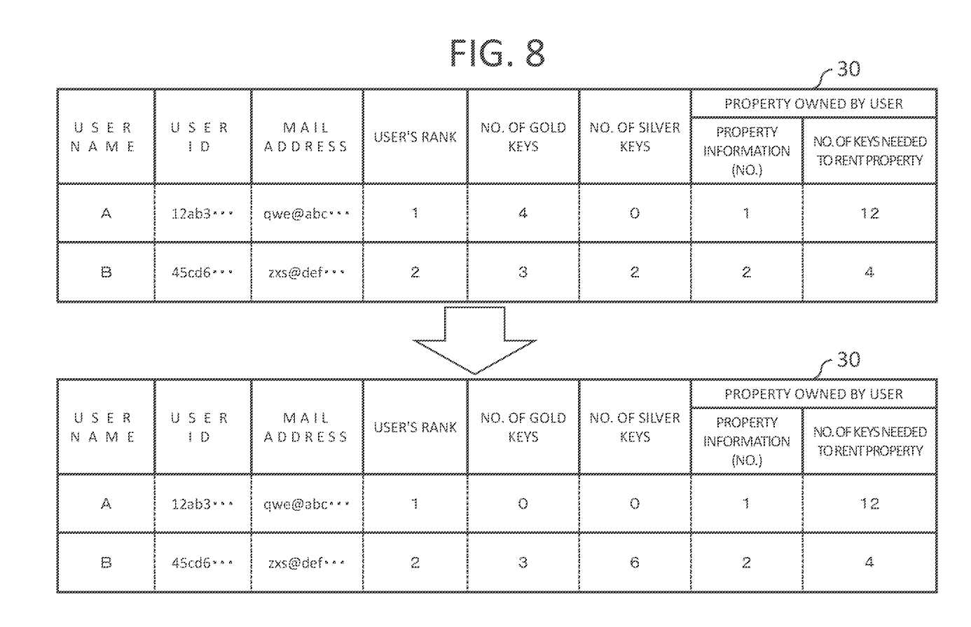

First, an operation will be described in which a rent payment for a second residence is settled using only gold keys. Here, for example, user A rents a property of property No. 2 owned by user B (see FIG. 8).

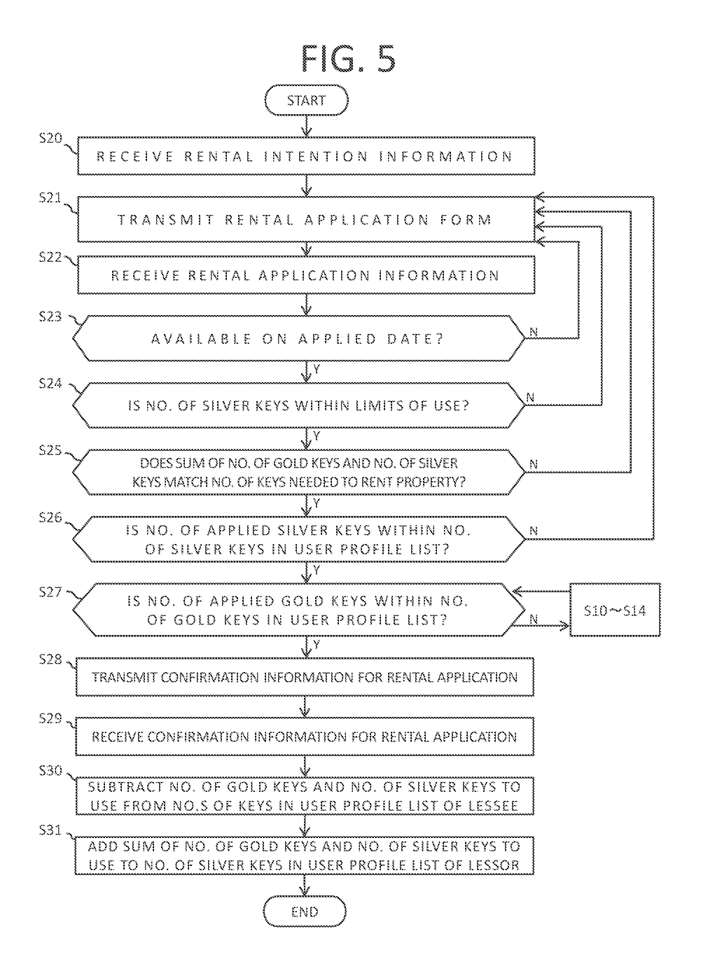

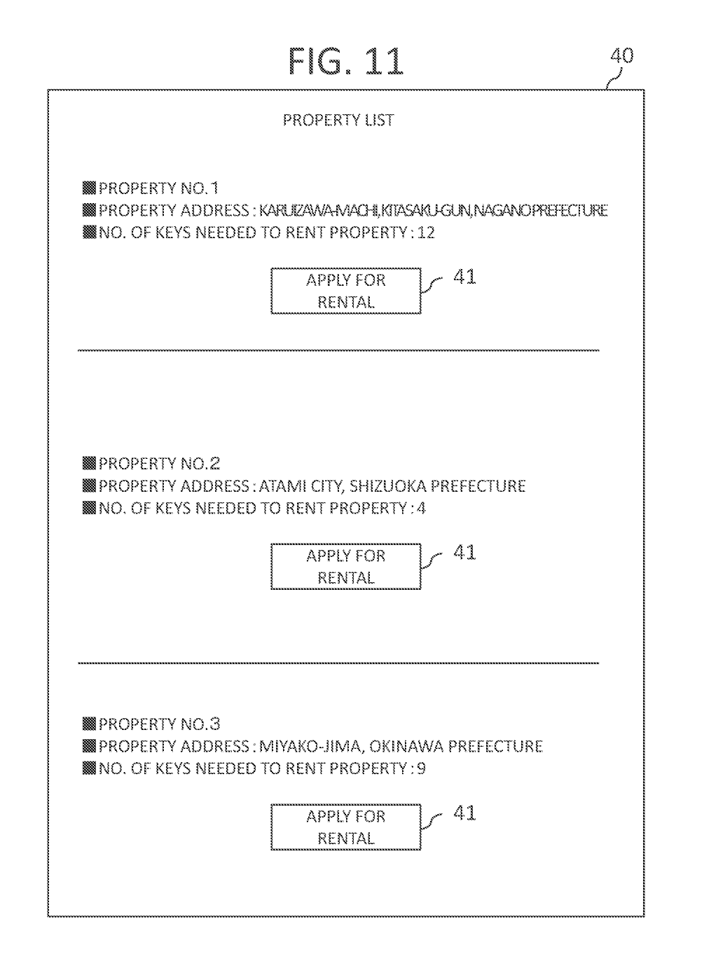

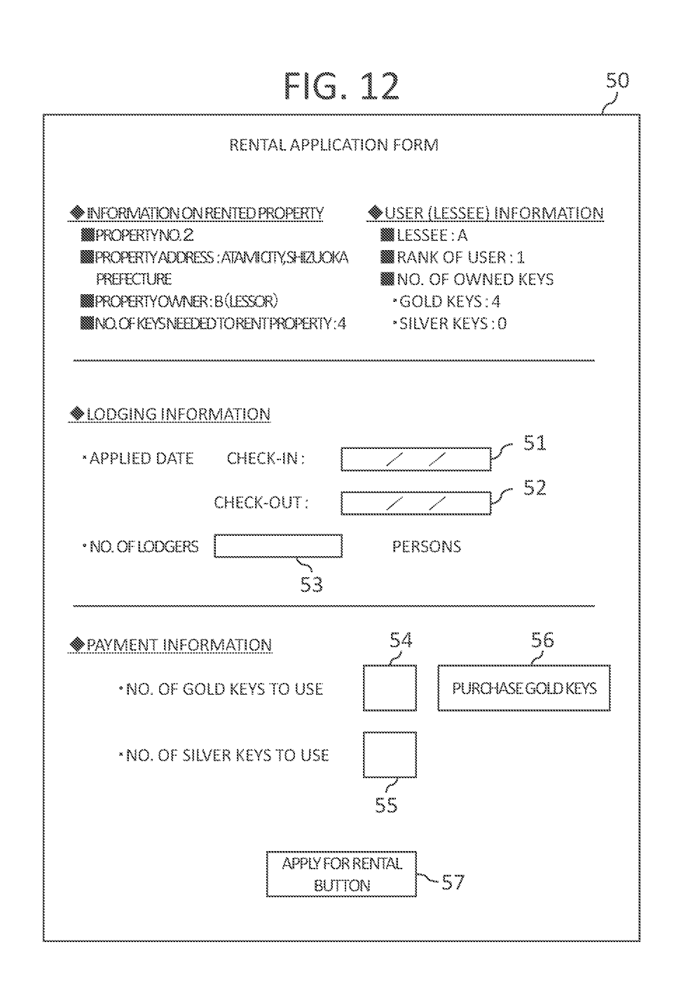

FIG. 5 is a flowchart showing procedures for settling a rent payment in the rental system according to the first embodiment of the present invention. FIG. 8 is a diagram showing an example of a user profile list in the rental system according to the first embodiment of the present invention. FIG. 11 is also a diagram showing a page of a property list displayed on the user terminal of the rental system according to the first embodiment of the present invention. FIG. 12 is a diagram showing a page of a Rental Application Form displayed on the user terminal of the rental system according to the first embodiment of the present invention.

Referring to FIG. 11, user A accesses to the present rental system with the user's own user terminal 200 (lessee terminal), and the management sever 100 of the present rental system outputs a property list page 40 containing the second residence for rent on the user terminal 200. The property list page 40 shows “Property No.”, “Property Address”, and “Number of Keys Needed to Rent Property”, allowing the user to select an intended second residence by comparing the information of listed properties. “Number of Keys Needed to Rent Property” on the property list page 40 means the number of keys needed to settle a rent payment for the second residence. And this number of keys is determined appropriately through consultation between the mediator and the user who is the owner of the property, for example, by taking valuation of the property into consideration. (The valuation of the property is determined, for example, by taking the location, neighborhood conditions, age, cleanliness, and the like of the property comprehensively into consideration). Also, the property list page 40 provides “Apply for Rental” buttons 41 for use to apply for rental of respective properties. The user selects an intended property and applies for renting the property using the “Apply for Rental” button 41.

Next, by user A clicking the “Apply for Rental” button 41 of property No. 2 on the property list page 40 with a mouse or the like (or directly tapping the Apply for Rental button 41), the user's own user terminal 200 transmits rental intention information to the management server 100.

In step S20, the management server 100 receives the rental intention information on property No. 2 transmitted from the user terminal 200 of user A via the communications unit 106 and stores the information in the memory 102.

Next, based on the rental intention information on property No. 2 stored in the memory 102, the management server 100 creates a rental application form for use to enter application information about renting of property No. 2, and transmits the form to the user terminal 200 of user A via the communications unit 106 in step S21.

When the user terminal 200 of user A receives the rental application form from the management server 100, the user terminal 200 displays the received Rental Application Form 50 (see FIG. 12). The Rental Application Form 50 provides a “Check-in Date” input field 51, a “Check-out Date” input field 52, and “Number of Lodgers” input field 53 for use by the user to enter lodging information; a “Number of Gold Keys (first keys) to Use” input field 54 and a “Number of Silver Keys (second keys) to Use” input field 55 for use to enter payment information on a property for rent; and a “Purchase Gold Keys” button 56 for use to apply for the purchase of the gold keys. Also, an “Apply for Rental” button 57 is provided in a bottom section of the Rental Application Form 50 to transmit various information entered on the Rental Application Form 50 to the management server 100.

Then, user A enters an intended check-in date, check-out date, and number of lodgers, respectively, in the input fields 51, 52, and 53 of the Rental Application Form 50 displayed on the user's own user terminal 200 and enters the number of gold keys to use and number of silver keys to use, respectively, in the input fields 54 and 55. Regarding the number of keys owned by user A here, the number of gold keys is “4” and the number of silver keys is “0”, as showing the upper side table in FIG. 8 as well as FIG. 12. Also, the “Number of Keys Needed to Rent Property” of property No. 2 user A intends to rent is “4” (see FIGS. 8 and 12). Thus, user A enters “4” in the input field 54 as the number of gold keys to use and enters “0” in the input field 55 as the number of silver keys to use (since the number of silver keys used here is “0,” this example is a case in which a payment for the second residence is settled using only gold keys).

Once the above-mentioned various information is entered in the input fields 51 to 55, user A clicks the “Apply for Rental” button 57 on the Rental Application Form 50 with a mouse or the like (or directly taps the “Apply for Rental” button 57), and thereby the user's own user terminal 200 transmits rental application information on property No. 2 to the management server 100.

Then, in step S22, the management server 100 receives the rental application information on property No. 2 transmitted from the user terminal 200 of user A, via the communications unit 106 and stores the received information in the memory 102.

Next, in step S23, based on the rental application information on property No. 2 stored in the memory 102, the management server 100 determines if property No. 2 is available on the applied lodging date of user A. For example, the management server 100 determines if there is any overlap between the period in which user A intends to lodge (period from the applied “Check-in Date” to the applied “Check-out Date” entered in the input fields 51 and 52 of the Rental Application Form 50) and the period in which another user has already applied to lodge (period from “Check-in Date” to “Check-out Date” transmitted to the management server 100 by the other user earlier than user A). And the management server 100 determines the lodging of user A in property No. 2 to be “unavailable” in the case that there is any overlap during the given period, and determines the lodging of user A in property No. 2 to be “available” in the case that there is no overlap during the given period.

When the management server 100 determines in step S23 that the lodging of user A in property No. 2 is “unavailable,” the management server 100 transmits another rental application form to the user terminal 200 of user A via the communications unit 106 (by returning to step S21). User A enters an intended check-in date and check-out date, respectively, in the input fields 51 and 52 of the Rental Application Form 50 again. Then, when the user terminal 200 of user A transmits the information to the management server 100, the management server 100 receives the information via the communications unit 106 (step S22), and determines again in step S23 if property No. 2 is available on the intended lodging date of user A.

When the management server 100 determines in step S23 that lodging of user A in property No. 2 is “available,” the management server 100 determines in step S24 if the number of silver keys to use entered by user A in the input field 55 of the Rental Application Form 50 is within limits of use for settling a rent payment. The determination is made, for example, based on whether or not the ratio between the gold keys and silver keys is within a predetermined range according to the rank of the user when the number of gold keys entered in the input field 54 of the Rental Application Form 50 and the number of silver keys entered in the input field 55 are combined. The management server 100 determines that lodging is “unavailable” when the number of silver keys to use exceeds the limits of use to settle the rent payment, and “available” when the number is within the limits of use. The determination is made, for example, using the following calculation formula.

B/A≦N <Calculation formula (1)>
wherein A is the number of first keys (gold keys) to use,
B is the number of second keys (silver keys) to use, and
N is an integer equal to or larger than 1 and represents a rank assigned by the ranking means.

Here, when the user satisfies a predetermined condition, the ranking means 13 updates the rank of the user and stores information thereon into the user profile list 30 (stores the information on the hard disk 105). Note that update conditions for the user's rank can be determined appropriately by the mediator, for example, based on the number of gold keys used by the user (e.g., use of “100” gold keys) or the number of silver keys acquired by the user, described later, (e.g., acquiring of “100” silver keys).

A couple of concrete examples will be described as follows how the management server 100 determines with calculation formula (1) above if the number of silver keys to use entered in the input field 55 of the Rental Application Form 50 is within the limits of use for settling rent payment. The examples will be described in detail associated with the rank of users who are classified into three ranks: 1 to 3.

A Case where User's Rank is “1” (Low)

In case the rank of a user is set at “1” by the ranking means 13, the number of silver keys available for settling the rent payment is as follows with calculation formula (1) above.

B/A≦1 <Calculation formula (1)>

### <Numerical Range of Silver Keys Available for a User Whose Rank is “1”>

B≦A

That is, from calculation formula (1) above, the number B of silver keys available for settling the rent payment by the user whose rank is “1” is B≦A in relation to the number A of gold keys. Consequently, calculation formula (1) above is not satisfied when the number B of silver keys to use is larger than the number A of gold keys, the management server 100 makes a decision of “unavailable” in the determination. Calculation formula (1) above is satisfied when the number B of silver keys to use is equal to or smaller than the number A, the management server 100 makes a decision of “available” in the determination.

A Case where User's Rank is “2” (Medium)

In case the rank of a user is set at “2” by the ranking means 13, the number of silver keys available for settling the rent payment is as follows with calculation formula (1) above.

B/A≦2 <Calculation formula (1)>

### <Numerical Range of Silver Keys Available for a User Whose Rank is “2”>

B≦2A

That is, from calculation formula (1) above, the number B of silver keys available for settling the rent payment by the user whose rank is “2” is B≦2A in relation to the number a of gold keys. Consequently, calculation formula (1) above is not satisfied when the number B of silver keys to use is larger than twice (2A) the number of gold keys, which is “1,” the management server 100 makes a decision of “unavailable” in the determination. Calculation formula (1) above is satisfied when the number B of silver keys to use is equal to or smaller than 2A, the management server 100 makes a decision of “available” in the determination.

A Case where User's Rank is “3” (Low)

In case the rank of a user is set at “3” by the ranking means 13, the number of silver keys available for settling the rent payment is as follows with calculation formula (1) above.

B/A≦3 <Calculation formula (1)>

### <Numerical Range of Silver Keys Available for a User Whose Rank is “3”>

B≦3A

That is, from calculation formula (1) above, the number B of silver keys available for settling the rent payment by the user whose rank is “3” is B≦3A in relation to the number a of gold keys. Consequently, calculation formula (1) above is not satisfied when the number B of silver keys to use is larger than three times (3A) the number of gold keys, which is “1,” the management server 100 makes a decision of “unavailable” in the determination. Calculation formula (1) above is satisfied when the number B of silver keys to use is equal to or smaller than 3A, the management server 100 makes a decision of “available” in the determination.

When the management server 100 determines if the number of silver keys to use entered by user A in the input field 55 of the Rental Application Form 50 is within the limits of use for settling a rent payment for property No. 2,
the rank of user A is “1” (see FIG. 8),
the number of gold keys entered by user A in the input field 54 of the Rental Application Form 50 is “4,” and
the number of silver keys entered by user A in the input field 55 of the Rental Application Form 50 is “0.”

When these numbers are substituted into calculation formula (1) above, the number of silver keys used by user A satisfies the condition of calculation formula (1) above as shown below. Thus, in this case, the management server 100 makes a decision of “available” in the determination.

0/4≦1 <Calculation formula (1)>

In case user A whose rank is “1” sets the number of silver keys to use at a number larger than “1” when the number of gold keys is “1,” (enters a number larger than “1” in the input field 55), calculation formula (1) above is not satisfied, thus, the management server 100 makes a decision of “unavailable” in the determination and transmits another rental application form to the user terminal 200 of user A again via the communications unit 106 (by returning to step S21). User A enters an appropriate number of silver keys to use in the input field 55 again (subsequently, steps S22 to S24 are repeated).

When the management server 100 makes a decision of “available” in the determination made in step S24, the management server 100 determines in step S25 if the sum of the number of gold keys and the number of silver keys used to settle the rent payment matches the number of keys needed to rent the property. Here,
the number of gold keys entered by user A in the input field 54 of the Rental Application Form 50 is “4,” and
the number of silver keys entered by user A in the input field 55 of the Rental Application Form 50 is “0,”
   while the number of keys needed to rent property No. 2 is “4” (see FIG. 8), and so the sum of the number of gold keys and the number of silver keys “4=4+0” used by user A to settle a rent payment for property No. 2 matches the number of keys “4” needed to rent property No. 2. Thus, in this case, the management server 100 makes a decision of “available” in the determination. In case the sum of the number of gold keys and the number of silver keys used by user A to settle the rent payment for property No. 2 does not match the number of keys needed to rent property No. 2, the management server 100 makes a decision of “unavailable” in the determination and transmits another rental application form to the user terminal 200 of user A again via the communications unit 106 (by returning to step S21). Then, user A enters an appropriate number of gold keys and number of silver keys to use in the input fields 54 and 55 again (subsequently, steps S22 to S25 are repeated).

When the management server 100 makes a decision of “available” in the determination made in step S25, the management server 100 determines in step S26 if the number of silver keys used to settle the rent payment (the number of silver keys entered in the input field 55 of the Rental Application Form 50) is within the number of silver keys of the user in the user profile list 30.

Here,
the number of silver keys entered by user A in the input field 55 of the Rental Application Form 50 is “0,”
   since the number of silver keys entered by user A in the input field 55 of the Rental Application Form 50 is “0” while the number of silver keys of user A in the user profile list 30 is “0” (see FIG. 8), the number of silver keys used by user A to settle the rent payment for property No. 2 is within the number of silver keys of user A in the user profile list 30. Thus, in this case, the management server 100 makes a decision of “available” in the determination. In case the number of silver keys used by user A to settle the rent payment for property No. 2 is larger than the number of silver keys of user A in the user profile list 30 (beyond the limit), the management server 100 makes a decision of “unavailable” in the determination and transmits another rental application form to the user terminal 200 of user A again via the communications unit 106 (by returning to step S21). User A enters an appropriate number of silver keys to use in the input field 55 again (subsequently, steps S22 to S26 are repeated).

When the management server 100 makes a decision of “available” in the determination made in step S26, the management server 100 determines in step S27 if the number of gold keys used to settle the rent payment (the number of gold keys entered in the input field 54 of the Rental Application Form 50) is within the number of gold keys of the user in the user profile list 30.

Here,
since the number of gold keys entered by user A in the input field 54 of the Rental Application Form 50 is “4,”
   while the number of gold keys of user A in the user profile list 30 is “4” (see the upper side table in FIG. 8), the number of gold keys used to settle the rent payment for property No. 2 is within the number of gold keys of user A in the user profile list 30. Thus, in this case, the management server 100 makes a decision of “available” in the determination. In case the number of gold keys used to settle the rent payment for property No. 2 is larger than the number of gold keys of user A in the user profile list 30 (beyond the limit), the management server 100 makes a decision of “unavailable” in the determination and repeats steps S10 to S14 again to allow user A to purchase gold keys at this stage. Subsequently the management server 100 makes a determination in step S27 anew.

Note that a “Purchase Gold Keys” button 56 for purchasing gold keys is provided on the Rental Application Form 50, and when clicked with a mouse or the like (or directly tapped) by user A, causes the management server 100 to carry out procedures for purchasing gold keys (steps S10 to S14). Thus, the user can purchase the number of gold keys necessary for settling a rent payment in advance when entering rental application information with the “Purchase Gold Keys” button 56.

When the management server 100 makes a decision of “available” in the determination made in step S27, the management server 100 transmits confirmation information for rental application on property No. 2 to the user terminal 200 of user A via the communications unit 106 in step S28. Then, when user A determines a rental application with the confirmation information for rental application on property No. 2 received from the management server 100, the user terminal 200 of user A transmits conclusive information for rental application on property No. 2 to the management server 100 from (where the conclusive information for rental application contains the number of gold keys, which is “4,” and number of silver keys, which is “0,” used to settle a rent payment for the property). (That is, key transmitting means 16 of the lessee terminal 200 transmits the number of first keys and the number of second keys used to settle the rent payment to the management server 100).

Then, in step S29, the management server 100 receives the conclusive information for rental application on property No. 2 transmitted from the user terminal 200 of user A, via the communications unit 106. (That is, the key receiving means 14 of the management server 100 receives the number of first keys and the number of second keys used to settle the rent payment from the lessee terminal 200). Note that the management server 100 stores the received conclusive information for rental application on property No. 2 in the memory 102.

Then, in step S30, based on the conclusive information for rental application on property No. 2 stored in the memory 102, the management server 100 subtracts the number of gold keys and the number of silver keys used by user A (lessee) to settle a rent payment for property No. 2 from the number of gold keys and the number of silver keys of user A in the user profile list 30 (where the conclusive information for rental application contains the number of gold keys, which is “4,” and number of silver keys, which is “0,” used to settle a rent payment for the property. That is, this information encompasses the number of first keys and the number of second keys used to settle a rent payment received by the key receiving means 14). Next, in step S31, the management server 100 adds the sum of the number of gold keys and the number of silver keys used by user A to settle the rent payment for property No. 2 as silver keys to the number of silver keys of user B who is the lessor of property No. 2 in the user profile list 30 (key transfer means 12).

To describe this concretely, first the management server 100 subtracts “4,” which is the number of gold keys used by user A to settle the rent payment for property No. 2 from “4,” which is the number of gold keys of user A in the user profile list 30, and then subtracts “0,” which is the number of silver keys used by user A to settle the rent payment for property No. 2 from “0,” which is the number of silver keys of user A in the user profile list 30. Consequently, both the number of gold keys and the number of silver keys of user A in the user profile list 30 become “0” (change from the upper side table to the lower side table in FIG. 8).

Then, the management server 100 adds the sum of the number of gold keys “4” and number of silver keys “0” used by user A to settle the rent payment for property No. 2 as the number of silver keys “4” to the number of silver keys “2” of user B (lessor of property No. 2) in the user profile list 30. Consequently, the number of silver keys of user B in the user profile list 30 becomes “6” (changes from the upper side table to the lower side table in FIG. 8).

In this way, the silver keys to settle the rent payment for property No. 2 used by user A who acts as lessee, are transferred directly as silver keys to user B who is the lessor of property No. 2. And the gold keys used by user A to settle the rent payment for the property are all transferred as silver keys to user B who is the lessor of the property. Incidentally, steps S30 and S31 are carried out based on the procedures beginning with step S24 above, and so the key transfer means 12 executes if the ratio between of the gold keys and silver keys satisfies the condition of

B/A≦N <Calculation formula (1)>

when the number of gold keys and the number of silver keys used to settle a rent payment for property are combined. Thus, the key transfer means 12 executes when the condition of calculation formula (1) is satisfied, the lessor of the property can acquire (obtain) silver keys by simply renting the property to the lessee.

Then, the management server 100 stores results of the subtraction and addition on the hard disk 105. Note that “the number of silver keys” of each user (e.g., user A, B, or C in FIG. 6) in the user profile list 30 is stored on the hard disk 105 by being associated with the status of the user as lessor or lessee. That is, “the number of silver keys” of each user is stored in the storage area allocated to the given user on the hard disk 105 (e.g., each storage area is allocated to each user), but “the number of silver keys” is stored in the storage area as “the number of silver keys of a lessor” when the given user is the lessor of the second residence, and as “the number of silver keys of a lessee” when the given user is the lessee of the second residence. Thus, “the number of silver keys” of each user in the user profile list 30 is stored on the hard disk 105 by being associated with the status of the user as lessor or lessee. That is, the hard disk 105 functions as the lessee key storing means 10 or the lessor key storing means 11 depending on the status of the user as lessor or lessee.

Thus, above explanation leads to the conclusion that the number of gold keys and the number of silver keys of user A as lessee of property No. 2 in the user profile list 30 are equal to the number of gold keys and the number of silver keys stored in the lessee key storing means 10, while the number of gold keys (“3;” see FIG. 8) and number of silver keys of user B who is the lessor of property No. 2 in the user profile list 30 are equal to the number of gold keys and the number of silver keys stored in the lessor key storing means 11. When user A becomes a lessor, the number of gold keys and the number of silver keys of user A in the user profile list 30 will surely be equal to the number of gold keys and the number of silver keys stored in the lessor key storing means 11, and when user B becomes a lessee, the number of gold keys and the number of silver keys of user Bin the user profile list 30 will be equal to the number of gold keys and the number of silver keys stored in the lessee key storing means 10.

This concludes the procedures for settling a rent payment using only gold keys in the present rental system. Then, the sum transmission means 15 of the management server 100 transmits via the communication unit 106, the information of the number of second keys (the sum of the number of second keys after the addition) stored in the lessor key storing means 11 after key transfer means 12 executing to a user terminal 200 (lessor terminal) of user B connected through the communication network. The sum receiving means 17 of the user terminal 200 of user B receives the sum of the number of second keys after the addition from the management server 100.

(b) Operation in which a Payment is Settled Using Silver Keys in Combination with Gold Keys

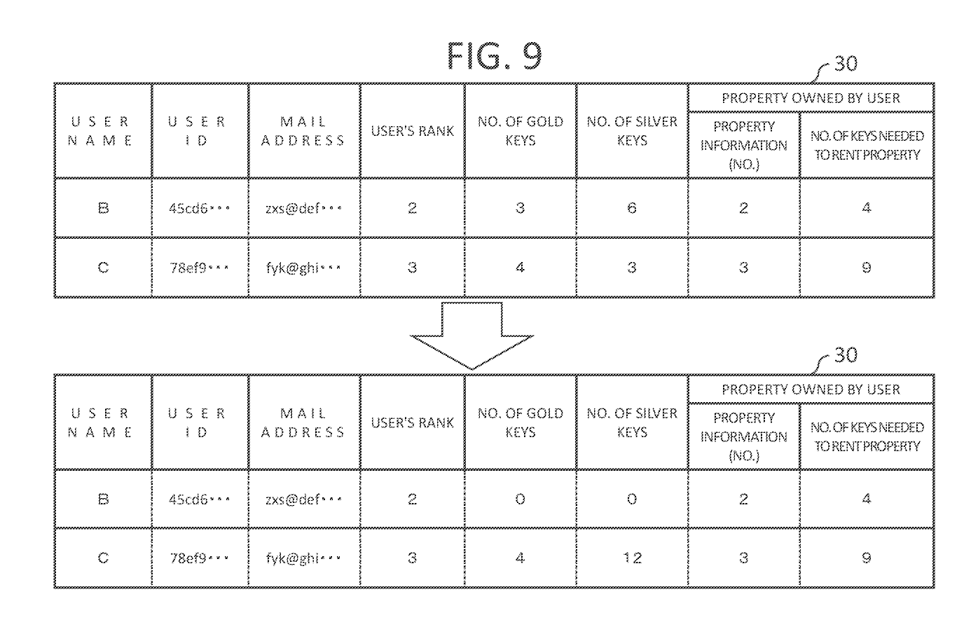

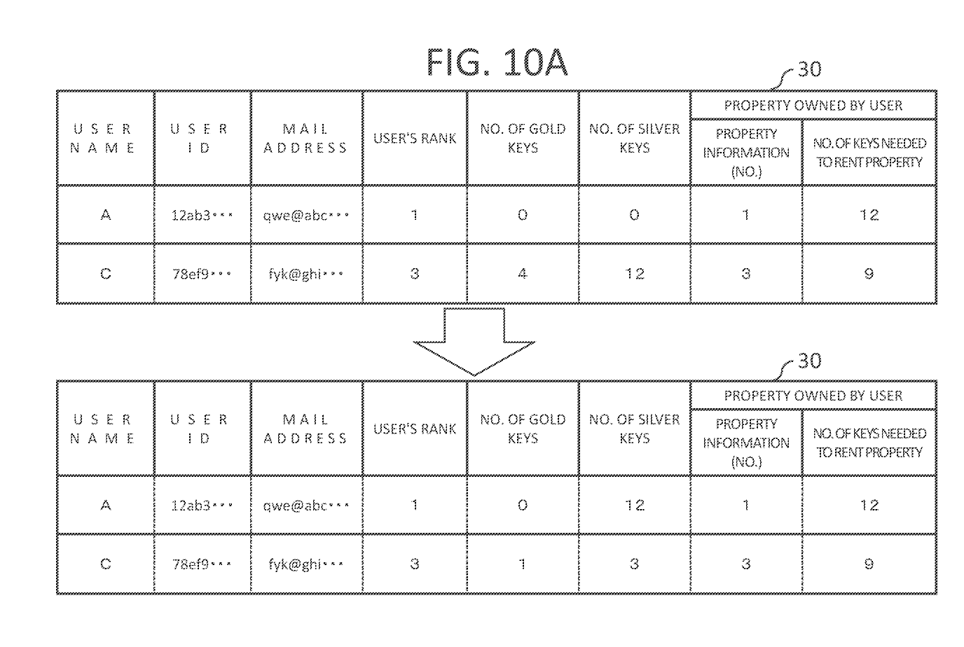

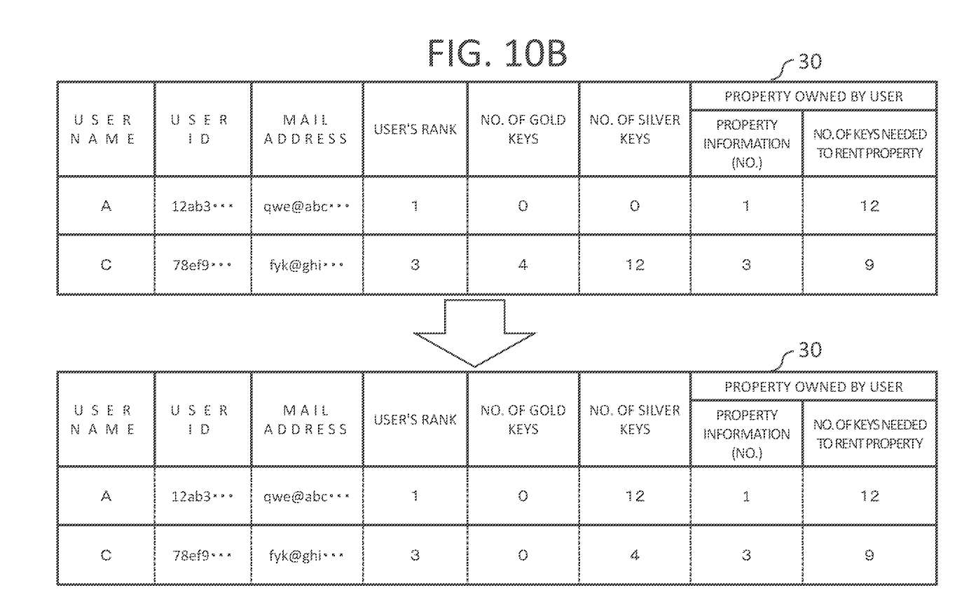

Next, an operation in which a rent payment for a second residence is settled using silver keys in combination with gold keys will be described by citing a case (A) and a case (B) (see FIGS. 9, 10A, and 10B):
(A) A case in which user B rents a property of property No. 3 owned by user C
(B) A case in which user C rents property of property No. 1 owned by user A

The operation performed by the management server 100 when a rent payment for a second residence is settled using silver keys in combination with gold keys is basically common with the above-described operation (steps S20 to S31) performed by the management server 100 when a rent payment for a second residence is settled using only gold keys, and thus step S24 and subsequent steps will mainly be described here by omitting basic procedures in steps S20 to S31.

(A) a Case in which User B Rents a Property of Property No. 3 Owned by User C

FIG. 9 is a diagram showing an example of a user profile list in the rental system according to the first embodiment of the present invention.

The number of keys needed to rent property of property No. 3 owned by user C is “9” as shown in FIG. 9, and user B enters “3” in the input field 54 of the Rental Application Form 50 as the number of gold keys to use, enters “6” in the input field 55 as the number of silver keys to use, and then the user's own user terminal 200 transmits this information (rental application information on property No. 3) to the management server 100.

Upon receiving the rental application information on property No. 3 from the user terminal 200 of user B (step S22), the management server 100 stores the information in the memory 102, and determines, based on this information, if the number of silver keys to use entered by user B in the input field 55 of the Rental Application Form 50 is within the limits of use to settle a rent payment (step S24).

When the management server 100 determines if the number of silver keys to use entered by user B in the input field 55 of the Rental Application Form 50 is within the limits of use to settle the rent payment for property No. 3,
the rank of user B is “2” (see FIG. 9),
the number of gold keys entered by user B in the input field 54 of the Rental Application Form 50 is “3,” and
the number of silver keys entered by user Bin the input field 55 of the Rental Application Form 50 is “6.”

When these numbers are substituted into calculation formula (1) above, the number of silver keys used by user B satisfies the condition of calculation formula (1) above as shown below. Thus, in this case, the management server 100 makes a decision of “available” in the determination.

6/3≦2 <Calculation formula (1)>

In case user B whose rank is “2” sets the number of silver keys to use at a number larger than “2” when the number of gold keys is “1” (enters a number larger than “2” in the input field 55), calculation formula (1) above is not satisfied, thus the management server 100 makes a decision of “unavailable” in the determination and transmits another rental application form to the user terminal 200 of user B again via the communications unit 106 (by returning to step S21). Then, user B enters an appropriate number of silver keys to use in the input field 55 again (subsequently, steps S22 to S24 are repeated).

When the management server 100 makes a decision of “available” in the determination made in step S24, the management server 100 determines in step S25 if the sum of the number of gold keys and the number of silver keys used to settle a rent payment matches the number of keys needed to rent property No. 3. Here,
the number of gold keys entered by user B in the input field 54 of the Rental Application Form 50 is “3,” and
the number of silver keys entered by user Bin the input field 55 of the Rental Application Form 50 is “6,”
   while the number of keys needed to rent property No. 3 is “9,” and so the sum of the number of gold keys and the number of silver keys “9=3+6” used by user B to settle the rent payment for property No. 3 matches the number of keys “9” needed to rent property No. 3. Thus, in this case, the management server 100 makes a decision of “available” in the determination. In case the sum of the number of gold keys and the number of silver keys used by user B to settle the rent payment for property No. 3 does not match the number of keys needed to rent property No. 3, the management server 100 makes a decision of “unavailable” in the determination and transmits another rental application form to the user terminal 200 of user B again via the communications unit 106 (by returning to step S21). Then, user B enters an appropriate number of gold keys and number of silver keys to use in the input fields 54 and 55 again (subsequently, steps S22 to S25 are repeated).

When the management server 100 makes a decision of “available” in the determination made in step S25, the management server 100 determines in step S26 if the number of silver keys used to settle the rent payment for property No. 3 (the number of silver keys entered in the input field 55 of the Rental Application Form 50) is within the number of silver keys of user B in the user profile list 30. Here,
since the number of silver keys entered by user B in the input field 55 of the Rental Application Form 50 is “6,”
   while the number of silver keys of user B in the user profile list 30 is “6” (see the upper side table in FIG. 9), the number of silver keys used by user B to settle the rent payment for property No. 3 is within the number of silver keys of user B in the user profile list 30. Thus, in this case, the management server 100 makes a decision of “available” in the determination. In case the number of silver keys used by user B to settle the rent payment for property No. 3 is larger than the number of silver keys of user B in the user profile list 30 (beyond the limit), the management server 100 makes a decision of “unavailable” in the determination and transmits another rental application form to the user terminal 200 of user B again via the communications unit 106 (by returning to step S21). User B enters an appropriate number of silver keys to use in the input field 55 again (subsequently, steps S22 to S26 are repeated).

When the management server 100 makes a decision of “available” in the determination made in step S26, the management server 100 determines in step S27 if the number of gold keys used to settle the rent payment for property No. 3 (the number of gold keys entered in the input field 54 of the Rental Application Form 50) is within the number of gold keys of user B in the user profile list 30. Here,
since the number of gold keys entered by user B in the input field 54 of the Rental Application Form 50 is “3,”
   while the number of gold keys of user B in the user profile list 30 is “3” (see the upper side table in FIG. 9), the number of gold keys used to settle the rent payment for property No. 3 is within the number of gold keys of user B in the user profile list 30. Thus, in this case, the management server 100 makes a decision of “available” in the determination. In case the number of gold keys used to settle the rent payment for property No. 3 is larger than the number of gold keys of user B in the user profile list 30 (beyond the limit), the management server 100 makes a decision of “unavailable” in the determination and repeats steps S10 to S14 again to allow user B to purchase gold keys at this stage. Subsequently the management server 100 makes a determination in step S27 anew.

Next, the management server 100 transmits confirmation information for rental application on property No. 3 to the user terminal 200 of user B via the communications unit 106 in step S28. Then, when conclusive information for rental application on property No. 3 is received from the user terminal 200 of user B, (That is, the key receiving means 14 of the management server 100 receives the number of first keys and the number of second keys used to settle the rent payment from the lessee terminal 200).

The management server 100 stores the received conclusive information for rental application on property No. 3 in the memory 102, and then subtracts the number of gold keys and the number of silver keys used by user B as lessee to settle the rent payment for property No. 3 from the number of gold keys and the number of silver keys of user B in the user profile list 30 (step S30), and adds the sum of the number of gold keys and the number of silver keys used by user B to settle the rent payment for property No. 3 as silver keys to the number of silver keys of user C who is the lessor of property No. 3 in the user profile list 30 (step S31, key transfer means 12).

To describe this concretely, first the management server 100 subtracts the number of gold keys “3” used by user B to settle the rent payment for property No. 3 from the number of gold keys “3” of user B in the user profile list 30 (stored in the lessee key storing means 10) and then subtracts the number of silver keys “6” used by user B to settle the rent payment for the property from the number of silver keys “6” of user B in the user profile list 30 (stored in the lessee key storing means 10). Consequently, both the number of gold keys and the number of silver keys of user B in the user profile list 30 become “0” (change from the upper side table to the lower side table in FIG. 9).

Then, the management server 100 adds the sum “9” of the number of the gold keys “3” and number of silver keys “6” used by user B to settle the rent payment for property No. 3 as the number of silver keys “9” to the number of silver keys “3” of user C (lessor of property No. 3) in the user profile list 30 (stored in the lessor key storing means 11). Consequently, the number of silver keys of user C in the user profile list 30 becomes “12” (changes from the upper side table to the lower side table in FIG. 9).

In this way, the silver keys to settle the rent payment for property No. 3 used by user B who acts as lessee, are transferred directly as silver keys to user C who is the lessor of property No. 3. And the gold keys used by user B to settle the rent payment for the property are all transferred as silver keys to user C who is the lessor of the property.

Then, the management server 100 stores results of the subtraction and addition on the hard disk 105.

This concludes the procedures for settling a rent payment for a second residence using silver keys in combination with gold keys (when user B rents the property of property No. 3 owned by user C in the present rental system. Then, the sum transmission means 15 of the management server 100 transmits via the communication unit 106, the information of the number of second keys (the sum of the number of second keys after the addition) stored in the lessor key storing means 11 after key transfer means 12 executing to a user terminal 200 (lessor terminal) of user C connected through the communication network. The sum receiving means 17 of the user terminal 200 of user C receives the sum of the number of second keys after the addition from the management server 100.

(B) A Case in which User C Rents Property of Property No. 1 Owned by User a

FIG. 10A is a diagram showing an example of a user profile list in the rental system according to the first embodiment of the present invention.

The number of keys needed to rent property No. 1 owned by user A is “12” as shown in FIG. 10A, and user C enters “3” in the input field 54 of the Rental Application Form 50 as the number of gold keys to use, enters “9” in the input field 55 as the number of silver keys to use, and then the user's own user terminal 200 transmits this rental application information on property No. 1 to the management server 100.

Upon receiving the rental application information on property No. 1 from the user terminal 200 of user C (step S22), the management server 100 stores the information in the memory 102, and determines, based on the information, if the number of silver keys to use entered by user C in the input field 55 of the Rental Application Form 50 is within the limits of use for a rent payment (step S24).

When the management server 100 determines if the number of silver keys to use entered by user C in the input field 55 of the Rental Application Form 50 is within the limits of use for a rent payment for property No. 1,
the rank of user C is “3” (see FIG. 10A),
the number of gold keys entered by user C in the input field 54 of the Rental Application Form 50 is “3,” and
the number of silver keys entered by user C in the input field 55 of the Rental Application Form 50 is “9,”
   when these numbers are substituted into calculation formula (1) above, the number of silver keys used by user C satisfies the condition of calculation formula (1) above as shown below. Thus, in this case, the management server 100 makes a decision of “available” in the determination.

9/3≦3 <Calculation formula (1)>

In case user C whose rank is “3” sets the number of silver keys to use at a number larger than “3” when the number of gold keys is “1” (enters a number larger than “3” in the input field 55), calculation formula (1) above is not satisfied, thus the management server 100 makes a decision of “unavailable” in the determination and transmits another rental application form to the user terminal 200 of user C again via the communications unit 106 (by returning to step S21). Then, user C enters an appropriate number of silver keys to use in the input field 55 again (subsequently, steps S22 to S24 are repeated).

When the management server 100 makes a decision of “available” in the determination made in step S24, the management server 100 determines in step S25 if the sum of the number of gold keys and the number of silver keys used to settle a rent payment matches the number of keys needed to rent property No. 1. Here,
the number of gold keys entered by user C in the input field 54 of the Rental Application Form 50 is “3,” and
the number of silver keys entered by user C in the input field 55 of the Rental Application Form 50 is “9,”
   while the number of keys needed to rent property No. 1 is “12,” and so the sum of the number of gold keys and the number of silver keys “12=3+9” used by user C to settle the rent payment for property No. 1 matches the number of keys “12” needed to rent property No. 1. Thus, in this case, the management server 100 makes a decision of “available” in the determination. In case the sum of the number of gold keys and the number of silver keys used by user C to settle the rent payment for property No. 1 does not match the number of keys needed to rent property No. 1, the management server 100 makes a decision of “unavailable” in the determination and transmits another rental application form to the user terminal 200 of user C again via the communications unit 106 (by returning to step S21). Then, user Centers an appropriate number of gold keys and number of silver keys to use in the input fields 54 and 55 again (subsequently, steps S22 to S25 are repeated).

When the management server 100 makes a decision of “available” in the determination made in step S25, the management server 100 determines in step S26 if the number of silver keys used to settle the rent payment for property No. 1 (the number of silver keys entered in the input field 55 of the Rental Application Form 50) is within the number of silver keys of user C in the user profile list 30. Here,
since the number of silver keys entered by user C in the input field 55 of the Rental Application Form 50 is “9,”
   while the number of silver keys of user C in the user profile list 30 is “12” (see the upper side table in FIG. 10A), the number of silver keys used by user C to settle the rent payment for property No. 1 is within the number of silver keys of user C in the user profile list 30. Thus, in this case, the management server 100 makes a decision of “available” in the determination. In case the number of silver keys used by user C to settle the rent payment for property No. 1 is larger than the number of silver keys of user C in the user profile list 30 (beyond the limit), the management server 100 makes a decision of “unavailable” in the determination and transmits another rental application form to the user terminal 200 of user C again via the communications unit 106 (by returning to step S21). User C enters an appropriate number of silver keys to use in the input field 55 again (subsequently, steps S22 to S26 are repeated).

When the management server 100 makes a decision of “available” in the determination made in step S26, the management server 100 determines in step S27 if the number of gold keys used to settle the rent payment for property No. 1 (the number of gold keys entered in the input field 54 of the Rental Application Form 50) is within the number of gold keys of user C in the user profile list 30. Here,
since the number of gold keys entered by user C in the input field 54 of the Rental Application Form 50 is “3,”
   while the number of gold keys of user C in the user profile list 30 is “4” (see the table in top the part of FIG. 10A), the number of gold keys used to settle the rent payment for property No. 1 is within the number of gold keys of user C in the user profile list 30. Thus, in this case, the management server 100 makes a decision of “available” in the determination. In case the number of gold keys used to settle the rent payment for property No. 1 is larger than the number of gold keys of user C in the user profile list 30 (beyond the limit), the management server 100 makes a decision of “unavailable” in the determination and repeats steps S10 to S14 again to allow user C to purchase gold keys at this stage. Subsequently the management server 100 makes a determination in step S27 anew.

Next, the management server 100 transmits confirmation information for rental application on property No. 1 to the user terminal 200 of user C via the communications unit 106 in step S28. Then, when conclusive information for rental application on property No. 1 is received from the user terminal 200 of user C, (That is, the key receiving means 14 of the management server 100 receives the number of first keys and the number of second keys used to settle the rent payment from the lessee terminal 200), the management server 100 stores the received conclusive information for rental application on property No. 1 in the memory 102, and then subtracts the number of gold keys and the number of silver keys used by user C as lessee to settle the rent payment for property No. 1 from the number of gold keys and the number of silver keys of user C in the user profile list 30 (step S30) and adds the sum of the number of gold keys and the number of silver keys used by user C to settle the rent payment for property No. 1 as silver keys to the number of silver keys of user A who is the lessor of property No. 1 in the user profile list 30 (step S31, key transfer means 12).

To describe this concretely, first the management server 100 subtracts the number of gold keys “3” used by user C to settle the rent payment for property No. 1 from the number of gold keys “4” of user C in the user profile list 30 (stored in the lessee key storing means 10) and then subtracts the number of silver keys “9” used by user C to settle the rent payment for the property from the number of silver keys “12” of user C in the user profile list 30 (stored in the lessee key storing means 10). Consequently, the number of gold keys of user C in the user profile list 30 becomes “1” and the number of silver keys becomes “3” (change from the upper side table to the lower side table in FIG. 10A).

Then, the management server 100 adds the sum (12) of the number of gold keys “3” and number of silver keys “9” used by user C to settle the rent payment for property No. 1 as the number of silver keys “12” to the number of silver keys “0” of user A (lessor of property No. 1) in the user profile list 30 (stored in the lessor key storing means 11). Consequently, the number of silver keys of user A in the user profile list 30 becomes “12” (changes from the upper side table to the lower side table in FIG. 10A).

In this way, the silver keys to settle the rent payment for property No. 1 used by user C who acts as lessee, are transferred directly as silver keys to user A who is the lessor of property No. 1. And the gold keys used by user C to settle the rent payment for the property are all transferred as silver keys to user A who is the lessor of the property.

Then, the management server 100 stores results of the subtraction and addition on the hard disk 105.

This concludes the procedures for settling a rent payment for a second residence using silver keys in combination with gold keys (when user C rents the property of property No. 1 owned by user A in the present rental system. Then, the sum transmission means 15 of the management server 100 transmits via the communication unit 106, the information of the number of second keys (the sum of the number of second keys after the addition) stored in the lessor key storing means 11 after key transfer means 12 executing to a user terminal 200 (lessor terminal) of user A connected through the communication network. The sum receiving means 17 of the user terminal 200 of user A receives the sum of the number of second keys after the addition from the management server 100.

As noted above, although an example has discussed in case that the number of gold keys used by user C to settle the rent payment for property No. 1 is “3” while the number of silver keys is “9,” user C whose rank is “3” can also use up to “3” (“3” or less) silver keys per “1” gold key. Thus, even when user C enters
“4” in the input field 54 of the Rental Application Form 50 as the number of gold keys to use, and
“8” in the input field 55 of the Rental Application Form 50 as the number of silver keys to use,
   and these numbers are substituted into calculation formula (1) above, the number of silver keys used by user C satisfies the condition of calculation formula (1) above as shown below. Thus, even in this case, the management server 100 makes a decision of “available” in the determination in step S24 (see FIG. 10B).

8/4≦3 <Calculation formula (1)>

In this case, because conditions of steps S25 to S27 are satisfied, first in step S30, the management server 100 subtracts the number of gold keys “4” used by user C to settle the rent payment for property No. 1 from the number of gold keys “4” of user C in the user profile list 30 (stored in the lessee key storing means 10), and then subtracts the number of silver keys “8” used by user C to settle the rent payment for the property from the number of silver keys “12” of user C in the user profile list 30 (stored in the lessee key storing means 10). Consequently, the number of gold keys of user C in the user profile list 30 becomes “0” and the number of silver keys becomes “4” (change from the upper side table to the lower side table in FIG. 10B).

Then, in step S31, the management server 100 adds the sum “12” of the number of gold keys “4” and number of silver keys “8” used by user C to settle the rent payment for property No. 1 as the number of silver keys “12” to the number of silver keys “0” of user A (lessor of property No. 1) in the user profile list 30 (stored in the lessor key storing means 11) (key transfer means 12). Consequently, the number of silver keys of user A in the user profile list 30 becomes “12” (changes from the upper side table to the lower side table in FIG. 10B).

In this way, the embodiment of the present invention subtracts the number of first keys and the number of second keys used to settle a rent payment received by the key receiving means 14 from the number of first keys and the number of second keys stored in the lessee key storing means respectively, and adds a sum of the number of first keys and the number of second keys used to settle the rent payment to the number of second keys stored in the lessor key storing means. Therefore, according to the present invention, a rental system can operate smoothly by using two different types of keys.

To describe this concretely, according to the present embodiment, by renting out real property to a lessee, the user as lessor can acquire the second keys which can be used in combination with the first keys needed to settle the rent payment for real property (i.e., in this case, the second keys are given to the lessor), but a condition necessary for the lessor according to the present embodiment to acquire second keys is only enough to rent out real property to the lessee, and no other condition is imposed on the lessor. Therefore, by simply renting out real property to the lessee, the lessor can easily acquire the second keys which can be used in combination with the first keys essential to settle the rent payment.

Also, the first keys according to the present embodiment are needed to settle the rent payment for real property, and when the lessee owns second keys in addition to the first keys (e.g., when the lessee has acquired second keys before by renting out real property as a lessor to another lessee), the lessee can settle a payment for real property using second keys in combination with first keys, and thus, in settling a rent payment for real property, the present invention can give a discount to the lessee according to the number of second keys used. That is, according to the number of second keys used in combination with the first keys, the lessee no longer needs to purchase some of the first keys needed to settle the rent payment for real property from a mediator, and thus the lessee is given a discount on an amount depending on the number of first keys which no longer need to be purchased.

Furthermore, in the present embodiment, in order for the lessee to settle a rent payment for real property, first keys are always necessary, and so the present invention configured as described above can reliably ensure profits of the mediator. That is, even if the lessee has acquired second keys before by renting out real property as a lessor to another lessee, the present embodiment does not allow the payment to be settled solely using second keys, and the lessee always needs to purchase first keys from the mediator in order to settle the payment. Therefore, when the payment is settled, the mediator can reliably ensure profits from an amount of the first keys paid by the lessee.

In addition, according to the present embodiment, since the key transfer means 12 executes when the ratio of the number B of second keys to the number A of first keys satisfies B/A≦N (where N is an integer equal to or larger than 1 and represents a rank assigned by the ranking means 13), the present invention can limit the number of second keys available for use according to the rank of the user (lessor or lessee).

Thus, the present invention provides a rental system which can give the lessor an incentive to acquire second keys, give the lessee an incentive to use second keys, and which can reliably ensure profits of the mediator who sells first keys.

### Variation of Rental System According to the Present Embodiment

Note that although in the present embodiment, a second residence (real property) owned by a user has been described byway of example as an object for rent, needless to say, personal property can be an object for rent in the present rental system.

Also, although in the present embodiment, operation to settle a rent payment for a second residence has been described in order from step S20 to step S31, as long as the key transfer means 12 executes following these steps, the management server 100 may operate in appropriately changing the order of steps S23 to S27 out of these steps. For example, the management server 100 may operate in the order: step S23, step S26, step S27, step S25, and step S24.

Furthermore, according to the present embodiment, the key transfer means 12 is designed to execute if the ratio between the gold keys and silver keys satisfies the condition of calculation formula (1) (B/A≦N) above when the number of first keys and number of second keys used to settle a rent payment for a second residence are combined, but the key transfer means 12 may be designed to execute instead, for example, if the condition of the following calculation formula is satisfied.

1≦B <Calculation formula (2)>

where B is the number of second keys used to settle a rent payment for personal property or real property.

That is, with this configuration, in order to settle a rent payment for personal property or real property (cause the key transfer means 12 to execute), “1” or more second keys are always needed in addition to the first keys. Therefore, if the key transfer means 12 is designed to execute if the condition of calculation formula (2) above is satisfied, the lessee can be requested to use second keys together with first keys (enter a number equal to or larger than “1” in the input field 55) in settling a rent payment for personal property or real property.

Also, the key transfer means 12 may be configured to execute if conditions of both calculation formula (1) and calculation formula (2) above according the present embodiment are satisfied. This always causes a number equal to or larger than “1” to be assigned to “B” (the number of second keys) in calculation formula (1), in order to satisfy the condition of calculation formula (2) and so the lessee can be requested to use second keys together with first keys (enter a number equal to or larger than “1” in the input field 55) in settling a rent payment for personal property or real property while limiting the available number of second keys according to the rank of the user (lessor or lessee).

Also, according to the present embodiment, when the numbers of first keys and second keys to use are combined, if the ratio between the gold keys and silver keys satisfies the condition of calculation formula (1) above, the user can change the numbers of first keys and second keys to use within this range (i.e., even if the numbers of first keys and second keys to use are changed, the key transfer means 12 executes as long as the condition of calculation formula (1) above is satisfied; see FIGS. 10A and 10B). However, the key transfer means 12 may be designed to execute instead, for example, if the number of first keys and number of second keys are specific values, respectively, depending on the number of keys needed to rent property (the number of keys needed to rent personal property or real property) when the first keys and second keys used by the user are combined. Concrete examples include the following combinations.

A Case where User's Rank is “1”

In case the number of keys needed to rent property is “6”: the number of first keys is “6” and the number of second keys is “0.”

In case the number of keys needed to rent property is “7”: the number of first keys is “7” and the number of second keys is “0.”

In case the number of keys needed to rent property is “8”: the number of first keys is “8” and the number of second keys is “0.”

A Case where User's Rank is “2”

In case the number of keys needed to rent property is “6”: the number of first keys is “4” and the number of second keys is “2.”

In case the number of keys needed to rent property is “7”: the number of first keys is “5” and the number of second keys is “2.”

In case the number of keys needed to rent property is “8”: the number of first keys is “6” and the number of second keys is “2.”

A Case where User's Rank is “3”

In case the number of keys needed to rent property is “6”: the number of first keys is “3” and the number of second keys is “3.”

In case the number of keys needed to rent property is “7”: the number of first keys is “4” and the number of second keys is “3.”

In case the number of keys needed to rent property is “8”: the number of first keys is “5” and the number of second keys is “3.”

That is, when a user whose rank is “1” wants to settle a rent payment for a property which requires “6” keys for rent, in order for the payment for the property to be authorized (in order for the key transfer means 12 to execute), it is necessary that the number of first keys to use is “6” while the number of second keys to use is “0,” and no other combination of the numbers of first keys and second keys causes the key transfer means 12 to execute (i.e., the user whose rank is “1” cannot use second keys).

Also, when a user whose rank is “3” wants to settle a rent payment for a property which requires “8” keys for rent, in order for the payment for the property to be authorized (in order for the key transfer means 12 to execute), it is necessary that the number of first keys to use is “5” while the number of second keys to use is “3,” and no other combination of the numbers of first keys and second keys causes the key transfer means 12 to execute.

In this way, when the first keys and second keys used by the user are combined, if the key transfer means 12 is designed to execute only when the number of first keys and number of second keys are specific values, respectively, depending on the number of keys needed to rent property (the number of keys needed to rent personal property or real property), combinations of the numbers of first keys and second keys needed in order to settle a rent payment for personal property or real property are fixed, and the user whose rank is “1” cannot use second keys. This makes the user think of purchasing a greater number of first keys from the mediator and using the first keys in an attempt to raise the user's ranking quickly. On the other hand, the user whose rank is “2” or above thinks of purchasing a greater number of first keys from the mediator in an attempt to complete a combination of the numbers of first keys and second keys and acquiring a greater number of second keys by renting out the user's personal property or real property to other users. Thus, by setting execution conditions of the key transfer means 12 in this way, it is possible to provide a rental system which can more reliably ensure profits of the mediator.

Also, according to the present embodiment, as described above, the key transfer means 12 is designed to execute only if the ratio between the gold keys and silver keys is within a predetermined range (if the condition of calculation formula (1) above is satisfied) in view of the rank of the user when the number of first keys and number of second keys to use are combined, but alternatively, a configuration which eliminates the ranking means 13 may be adopted instead, eliminating the need for the condition of calculation formula (1) above as well. In this case, there is no limit on the number of second keys used by the user to settle the rent payment for personal property or real property, and thus as long as at least “1” first key is used to settle the rent payment, it only remains to combine a necessary number (the remaining number of keys added to reach the number of keys needed to rent the property) of second keys with the first key, and the key transfer means 12 can be made to execute.

In this way, even if a configuration without the ranking means 13 is adopted, eliminating the need for the condition of calculation formula (1) above, in order to settle a rent payment for personal property or real property (to make the key transfer means 12 execute), at least “1” first key is essential and the user can use a greater number of second keys when renting personal property or real property. This makes it possible to provide a rental system which can more reliably ensure profits of the mediator. If the condition of calculation formula (2) above is added to this configuration, the lessee can be requested to use second keys together with first keys (enter a number equal to or larger than “1” in the input field 55) for a rent payment for personal property or real property.

Finally, the rental system of the present embodiment may be a rental method or implemented as a program product for causing a computer to perform as a rental system or method. The program product may be stored in a non-transitory computer-readable storage medium. Note that the storage medium may be a ROM itself of the rental system according to the present embodiment; a CD-ROM which is readable when inserted into an external storage device (CD-ROM drive or the like), a magnetic tape, a cassette tape; a flexible disk; a hard disk; MO, MD, DVD, or a similar disk; or a semiconductor memory.

Some variations of the present embodiment have been described above so far, but needless to say, these variations can be used in combination as appropriate.

Thus, it goes without saying that various changes can be made to the present embodiment without departing from the spirit of the present invention.

What is claimed is:

1. A rental system, comprising:
a lessee key storing means for storing a number of first keys and a number of second keys associated with a lessee;
a lessor key storing means for storing a number of first keys and a number of second keys associated with a lessor;
a key receiving means for receiving a number of first keys and a number of second keys used to settle a rent payment from a lessee terminal through a communication network;
a key transfer means for subtracting the number of first keys and the number of second keys used to settle the rent payment received by the key receiving means from the number of first keys and the number of second keys stored in the lessee key storing means respectively, and adding a sum of the number of first keys and the number of second keys used to settle the rent payment to the number of second keys stored in the lessor key storing means, and thereby transferring the number of the first keys used to settle the rent payment as the number of the second keys from the lessee key storing means to the lessor key storing means; and
a sum transmission means for transmitting the information of the number of second keys stored in the lessor key storing means to a lessor terminal through the communication network;
wherein the first keys are keys essential to settle the rent payment, and
the second keys are keys used to settle the rent payment in combination with the first keys.

2. The rental system according to claim 1, further comprising ranking means for ranking users, wherein:
the key transfer means executes when a ratio of a number B of second keys to a number A of first keys satisfies
B/A≦N
wherein N is an integer equal to or larger than 1 and represents a rank assigned by the ranking means.

3. The rental system according to claim 1, wherein the key transfer means executes when a number B of second keys used to settle the rent payment is
1≦B.

4. The rental system according to claim 2, wherein the key transfer means executes when the number B of second keys used to settle the rent payment is
1≦B.

5. A rental method used in a rental system as in claim 1, wherein
receiving the number of first keys and the number of second keys used to settle the rent payment from the lessee terminal through the communication network at the key receiving means,
subtracting the number of first keys and the number of second keys used to settle the rent payment from the number of first keys and the number of second keys stored in the lessee key storing means respectively at,
adding, at the key transfer means, a sum of the number of first keys and number of second keys used to settle the rent payment to the number of second keys stored in the lessor key storing means, and thereby
transferring, at the key transfer means, the number of first keys used to settle the rent payment as the number of second keys from the lessee key storing means to the lessor key storing means, and
thereafter, transmitting, at the sum transmission means, the information of the number of second keys stored in the lessor key storing means to the lessor terminal through the communication network.

6. A non-transitory computer-readable recording medium in which a program is recorded, the program causing the rental system to perform the method according to claim 5.

7. A computer program product embodied in a non-transitory computer-readable recording medium, the computer program product causing the rental system to perform the method according to claim 5.
